(19) United States
(12) Patent Application Publication
(10) Pub. No.: US 2006/0163027 A1
(43) Pub. Date: Jul. 27, 2006

(54) Device for handling banknotes

(75) Inventors: Ralf Hobmeier, Muenchen (DE); Christoph Ernesti, Unterhaching (DE); Michael Stapfer, Muenchen (DE); Walter Kraemer, Wiedergeltingen (DE)

Correspondence Address: ROTHWELL, FIGG, ERNST & MANBECK, P.C., 1425 K STREET, N.W., SUITE 800, WASHINGTON, DC, 20005, US

(73) Assignee: Giesecke & Devrient GmbH, Muenchen (DE)

(21) Appl. No.: 10/507,438

(22) PCT Filed: Mar. 10, 2003
(86) PCT No.: PCT/EP03/02433

§ 371 Date: Sep. 13, 2004

(30) Foreign Application Priority Data
Mar. 12, 2002 (DE) 102 10 687.8

(51) Int. Cl. G07D 7/00; G07F 7/04; G06K 9/00; G06K 7/00

(52) U.S. Cl. 194/207

(57) ABSTRACT

An apparatus for processing bank notes having a transport system with a plurality of transport paths for transporting bank notes. To provide an apparatus of particularly flexible and compact design, a bidirectionally drivable transport path is provided between two transport path branches.

This application is a National Phase of International Application Serial No. PCT/EP03/02433, filed Mar. 10, 2003.

### FIELD OF THE INVENTION

This invention relates to an apparatus for processing bank notes having a transport system with a plurality of transport paths for transporting bank notes.

### DESCRIPTION OF THE BACKGROUND ART

Such bank note processing apparatuses are known in the form of counting and/or sorting apparatuses and/or bank note inputting and/or outputting apparatuses in which bank notes are transported to and from single parts of the apparatus in desired fashion. Although intended nonrestrictively, the following specification will deal with the special problems of deposit apparatuses, since the inventive solution can be used particularly advantageously in such deposit apparatuses.

EP 0 811 208 B1 describes an example of such an apparatus. Bank notes are inputted in bundles, singled, tested, the accepted bank notes supplied to an escrow via a first single diverter, and the unaccepted bank notes supplied to a separate return pocket via a following second single diverter. If the user agrees to the final deposit of the accepted bank notes, they are diverted from the escrow via the first and second single diverters to an end cashbox in the form of a cassette.

A disadvantage of this system is that the arrangement of the various components is fixed by the choice of the diverter configuration.

### SUMMARY OF THE INVENTION

On these premises, it is the problem of the present invention to permit different arrangements of an apparatus for processing bank notes to be realized in a simple and flexible way.

An essential aspect of the present invention is thus to provide a bidirectionally drivable transport path between two transport path branches. A transport path branch is understood here to mean a transport node at which bank notes can be diverted to different transport routes, e.g. by means of a diverter. A bidirectionally drivable transport path is understood to mean a transport path that is coupled or adapted to be coupled with a control device of the apparatus to permit bank notes in said transport path to be transported in two opposite directions.

This has the advantage that, e.g. in a deposit apparatus, the individual components of the apparatus, such as input, return, escrow and/or end cashbox, can be connected to the individual inputs/outputs of the diverter device in any desired way. Said connection can be effected very compactly and in dependence e.g. on the desired outer dimensions of the apparatus.

In contrast, the diverter arrangement according to EP 0 811 208 B1 has a solely unidirectionally driven transport path between its two single diverters. With this known arrangement, the arrangement of escrow and end cashbox is mandatory for example, since bank notes must be inputted to and outputted from the escrow bidirectionally. However, the inventive solution, because of the presence of the bidirectional transport path, for example also permits the return and/or end cashbox to be connected to the first diverter and not necessarily only to the second diverter.

A particularly compact apparatus can be realized when the diverter device has a diverter module as a separate component, which is removable e.g. for maintenance purposes and/or can be opened to clear a jam.

### BRIEF DESCRIPTION OF THE DRAWINGS

Some basic ideas and embodiments of the present invention will be explained and described in more detail hereinafter with reference to the enclosed drawings.

It should be specially emphasized that the single features of the embodiments stated in the description can also be advantageously used independently of each other and of the subject matter of the main claim in other bank note processing apparatuses, in particular other bank note deposit apparatuses.

FIG. 1 shows a schematic side view of a bank note deposit device;

FIG. 2 shows a schematic side view of a basic module of the bank note deposit device according to FIG. 1;

FIG. 3 shows a laterally reversed view of a schematic representation of drive components of a basic module of the bank note deposit device according to FIG. 1;

FIG. 4 shows a schematic representation of parts of a direction of rotation converter transmission according to FIG. 3;

FIG. 5 shows a schematic side view of a single diverter in four different operating states which is used in the bank note deposit device according to FIG. 1;

FIG. 6 shows a schematic side view of three different embodiments of a transport node with a diverter arrangement comprising two single diverters according to FIG. 5;

FIG. 7 shows a schematic side view of an escrow module 6 of FIG. 1;

FIG. 8 shows a cross-sectional view through a peeling roller which is used in the escrow module of FIG. 7; and

FIG. 9 shows a cross-sectional view through a spool which can be used in the escrow module of FIG. 7.

### DETAILED DESCRIPTION OF THE INVENTION

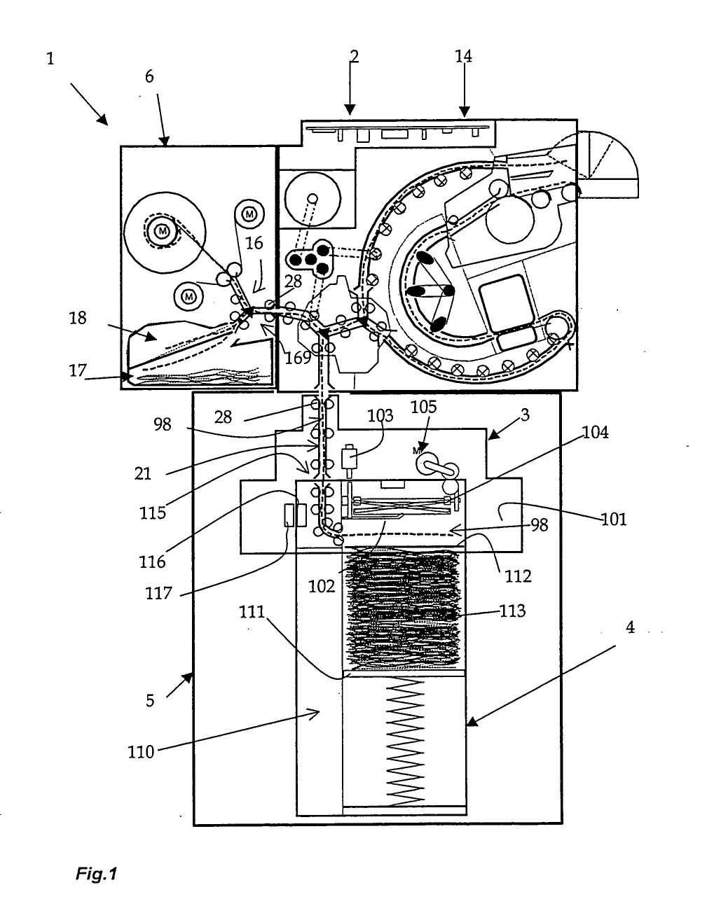

FIG. 1 shows a schematic side view of a bank note deposit device 1. To permit the different requirements of various users for such a product to be more easily fulfilled, a modular structure of the device 1 is preferably realized, although all parts stated hereinafter can alternatively be connected in a single, nonmodular arrangement. This means that different functional parts can be combined by means of unified interfaces preferably into a device 1 with desired properties. The device 1 consists by way of example of a basic module 2 and the following optional modules: an escrow 6, a cassette carrier 3, an end cashbox 4 in the form of a cassette 4, whereby at least some of the modules, in particular the cassette carrier 3 and the end cashbox 4, are preferably inserted in a safe 5.

For this purpose the basic module 2 has a metal chassis 14 which is the supporting element of the device 1. All device components are fastened thereto. The chassis 14 is self-supporting and constitutes outwardly the physical interface for example to an automatic teller machine in which the device 1 is installed. The automatic teller machine then constitutes an outer casing of the device 1 and includes an operating unit connected to a control unit 13 of the basic module 2 by means of a signal line.

The chassis 14 of the basic module 2 has cassette carrier 3 and/or the escrow 6 fastened thereto. For variants with or without escrow 6, the chassis 14 of the basic module 2 is preferably executed identically. For integration in the automatic teller machine, the chassis offers fastening points at which the basic module 2 can be hung. The fastening points are so designed that they can constantly take the total weight of the device 1.

The structure and function of the individual modules will hereinafter be described in more detail in separate sections.

Basic Module

Fundamental Structure

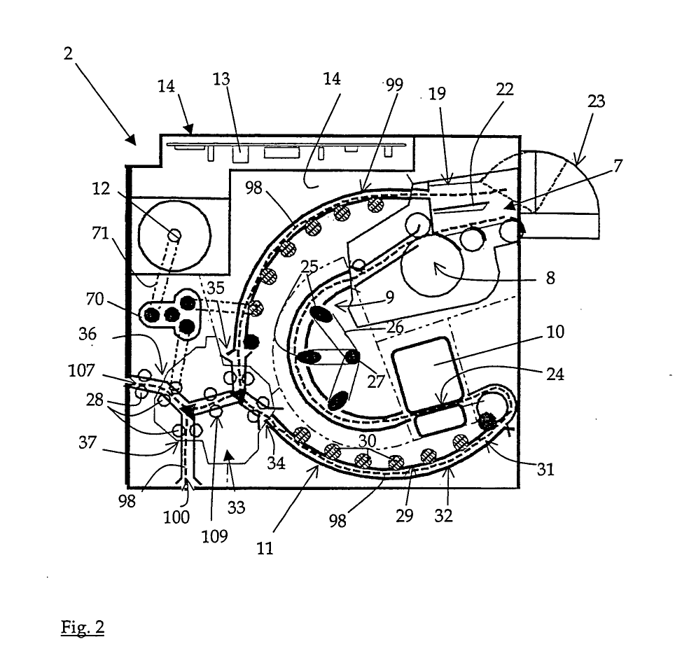

The basic module 2, which can in particular also be recognized in FIG. 2, is designed as a bank note testing device and comprises as functional assemblies an input pocket 7, a return pocket 19, a singler 8, a sensor device 10 and the control unit 13, which are mounted on the chassis 14.

Further, the basic module 2 comprises a transport system which transports the bank notes between the single assemblies. Said transport system includes for example a transport path 9 with an aligning function, called aligning path 9 for short, which transports the bank notes singly from the input pocket 7 after singling by the singler 8 to a measuring path 24 of the sensor device 10. This is followed by an evaluating path 11 as a further transport path, which conveys the bank notes further after they have traversed the measuring path 24 of the sensor device 10.

The aligning path 11 opens into a diverter module 33 as a diverter device which then conveys the bank notes alternatively to a further transport path 99 leading to the return pocket 19, a further transport path 107 to the escrow 6, or a further transport path 100 via the cassette carrier 3 to the end cashbox 4. The possible transport routes of the bank notes in the device 1 are indicated in FIGS. 1, 2 and 7 by dotted lines 98.

The control unit 13 controls, among other things, a drive unit 12 for driving the individual transport elements 8, 9, 10, 24, 33, 99, 100, 107.

Input/Return

The input pocket 7 is used for inputting loose bundles of bank notes to be deposited. The operator can input a bundle of bank notes. The return pocket 19 is used for returning so-called reject bank notes to the depositor. Reject bank notes are bank notes that could not be judged correctly by the sensor device 10 since they were e.g. skewed or out of line and/or they were subject to other reasons for rejection such as multiple picks. Said bank notes are preferably passed into the return pocket 19 without intermediate storage by means of the diverter module 33 and the transport path 99 after traversing the evaluating path 10.

The input pocket 7 and the return pocket 19 can advantageously be designed as a combined input/output pocket, as described by way of example in the applicant's PCT application PCT/EP01/01902, which is hereby to be deemed part of this application. The input and output pockets 7, 19 are thus separated only by a thin, movable partition 22 and are closed by a common swiveling cover 23 in a closed position shown by an unbroken line and made accessible in an open position indicated by a dotted line. For inputting sheet material, the partition 22 is swiveled by a servomotor against an upper wall of the input pocket 7 in the open position of the cover 23 so that input pocket 7 and return pocket 19 form a continuous, large input space.

Aligning Path

The bank notes are singled out of the input pocket 7 by means of a per se known singler 8 and delivered to the connected aligning path 9. Bank notes in the format 100-185 mm long and 60-95 mm wide can preferably be processed. The BN transport is executed throughout the device as a sequential single bill transport preferably in the longitudinal direction.

The aligning path 9 can advantageously be designed as described in the applicant's PCT application PCT/EP01/15016, which is hereby to be deemed part of this application. The aligning path 9 is consequently provided with aligning means 25 which put the bank notes in a defined position and/or moving direction while the latter are singly traversing the aligning path 9.

To make alignment of the bank notes reliable and as trouble-free as possible, it is provided that the aligning path 9 is curved in the moving direction of the bank notes. The aligning path according to FIG. 1 has by way of example a curvature in the form of a “C”. A bank note traversing the aligning path 9 thus follows the curvature extending in the moving direction and is thereby curved itself. The curvature increases the stiffness of the bank note in comparison with the flat position. Thus, even sheets with high limpness show sufficient stability so as not to be deformed or folded during the aligning process.

The aligning means 25 comprises e.g. one or more polygonal wheels 25 at an angle to the transport direction which move the bank notes against a stop and thereby align them. In addition to said wheels, polygonal or circular wheels 25 can be inserted which act in the transport direction to prevent a reduction of transport speed of the bank notes. The wheels 25 are driven centrally via round belts 26. For this purpose a central driving roller 27 is connected to the individual wheels 25 via the round belts 26. The central roller 27 itself can be driven by a separate drive unit, but preferably by the common drive unit 12 of the basic module 2.

Sensor Device

The aligning path 9 is followed by a measuring path 24 comprising a sensor device 10, which can be designed as known in the art for testing properties of the bank notes, such as authenticity and/or value and/or state. An advantage of having the aligning path 9 upstream is that the bank notes can always be transported to, and consequently through, the measuring path in a matching, aligned position. This greatly simplifies the evaluation in the sensor device 10. The measuring path 24 is preferably designed here as a belt transport system to be described more exactly hereinafter in the section “Transport systems”. It is designed so as to guarantee a preferably constant transport speed in the sensor measuring area 24. The alignment and the constancy of speed notably simplify the evaluation in the sensor device 10. This is further supported by the measuring path 24 being of straight design.

Evaluating Path

The measuring path 24 of the sensor device 10 is followed by the evaluating path 11. The latter is preferably designed as a flat belt transport system to be described more exactly hereinafter in the section “Transport systems”. The evaluating path 11 opens into an input channel 34 of the diverter module 33.

Upstream of the latter is a bank note detecting element, such as a light barrier (not shown), which detects bank notes as they pass by. It is essential that the length of the evaluating path 11 and the transport speed of the bank notes in said evaluating path 11 are coordinated so that the measuring data of the sensor device 11 can be evaluated before the light barrier is reached, to permit the diverter module 33 to be switched accordingly to be able to divert the bank notes to the escrow 6, the return pocket 19 or the end cashbox 4.

Further Transport Paths

An output channel 35 of the transport node 33 opens into the further transport path 99 which leads to the return pocket 19 and is preferably likewise designed as a flat belt transport system. The further output channels 36 and 37 lead via the transport paths 107 and 100 to the escrow 6 and to the cassette carrier unit 3/end cashbox 4, respectively, and are designed as path sections of short length, preferably as a roller transport system.

Transport System

The transport system of the basic module 2 thus comprises a plurality of transport paths connected via the diverter module 33 and a corresponding driving system. The total transport system, also the transport in the optional modules 3, 4, 6, is preferably driven centrally via a drive unit 12, as will be described hereinafter in greater detail. Individual components, such as in particular the singler 8, can be separated by a coupling if required. The transport speed is preferably lower in the singler than in the connected transport paths. Three transport principles are preferably realized in the transport system:

a) Roller Transport:

Firstly a roller transport, using for example a belt-free transport, e.g. with elastic clamping roller pairs 28, i.e. with fixed, unsprung driving and transport rollers (counter rollers). This space-saving roller transport is applicable in particularly suitable fashion in the area of transport nodes, i.e. in the case of diverter arrangements and/or short transport sections. Advantageously, only one of the two rollers 28 of a pair is actively driven. This has the advantage that the system can be constructed so as to be easily opened by swinging away the undriven side of the roller pairs 28 to permit a possible bank note jam to be easily cleared.

b) Belt Transport

A belt transport system is used in particular for the measuring path 24 of the sensor device 10. It can specifically be a belt transport with three belts. In the area of the sensor device 10 a plurality of narrow parallel (toothed) belts run along with the bank note on one side. A belt tightener keeps the clamping force momentum-independent and constant. Particularly preferably the sensor belt loop 24 is entrained, i.e. driven, by the following flat toothed belt loop of the evaluating path 11 and thus does not need to have an additional drive unit. Access to the transport path can in this case be easily obtained by pulling out the module of the sensor device 10.

c) Flat Belt Transport

Such a flat belt transport 11 follows for example the measuring path 24 of the sensor device 10. It comprises a transport belt 29, preferably a single synchronous toothed belt 29, which also drives all rollers 30 involved in/coupled to the belt loop. This greatly simplifies the drive, since one drive level can be omitted. The transport route is formed here by a flat channel 31. For this purpose a guide surface 32 is fastened on the side opposing the transport belt, between which the bank notes are transported in clamped fashion. The flat channel 31 is preferably of curved form. The clamping forces therefore result e.g. by the back of the toothed belt wrapping around the stationary rollers 30. This permits the otherwise necessary sprung rollers of the other side to be dispensed with.

Advantageously a belt tightener is used to permit the clamping force to be kept momentum-independent and constant. As an opening concept it is preferably provided that either only the roller-side or only the non-roller-side guide plate 32 can be removed to permit a possible bank note jam to be easily cleared.

Since each belt loop contains only one driving roller, all others can be executed as rollers with stationary axles (rotating roller bodies or toothed belt pulleys). The latter are not exposed to any alternate bending by pull of the belt (as in the case of round belt pulleys) and serve further to stiffen chassis 14 when installed therein.

Diverter Device

The diverter module 33 is one of the essential parts of the basic module 2. As can be seen in particular in FIG. 2, it is preferably a separate component 33 which produces transport connections between four input and output channels 34-37. The diverter module 33 is thus a central node in the transport system through which the bank notes must in any case run during processing and which produces a connection from the input 7 to all potential deposit possibilities of the inputted bank notes, i.e. to the escrow 6, the return pocket 19 and the end cashbox 4. The transport elements of the diverter module 33 are preferably designed as a roller transport system because of the short transport paths in the diverter module 33.

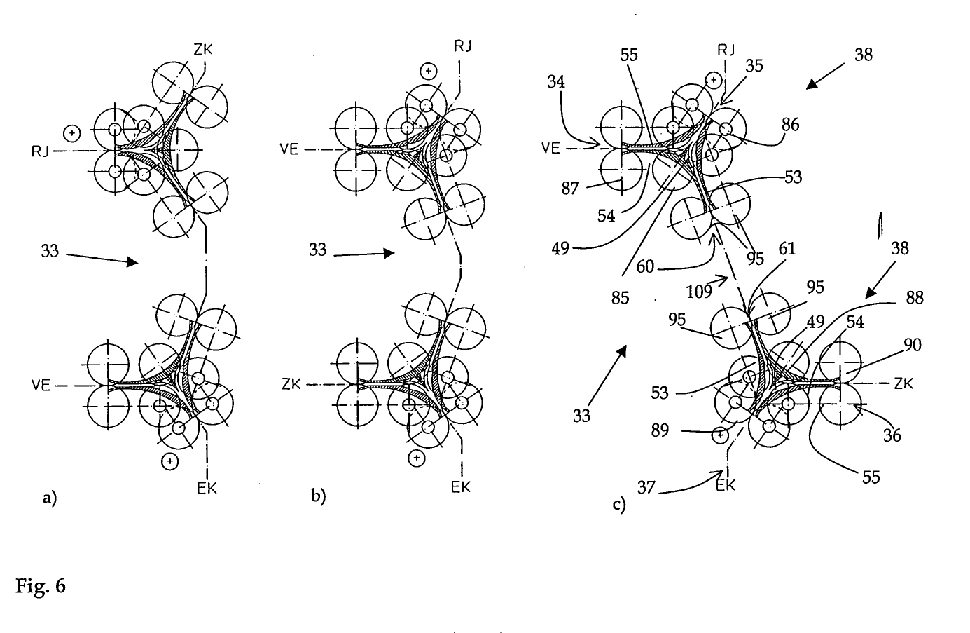

The diverter module 33 can preferably be composed of two interconnected single diverters 38. First the properties of such a single diverter 38 will be described in particular with reference to FIG. 5, and then possible embodiments of the associated diverter module 33 with reference to FIG. 6.

Single Diverter

FIGS. 5a)-d) show a single diverter 38 in four different operating states, whereby for clarity's sake the associated reference signs are not always stated in all FIGS. 5a)-d). The single diverter 38 is described here by the following properties.

It has three transport channels 50-52, which are formed e.g. by three guide elements such as guide surfaces 53-55, which are disposed in a Y form. At the outputs of the three channels 50-52 transport roller pairs 42/43, 44/45, 46/47 are rotatably mounted for conveying the bank notes in a clamped state into and/or out of the associated transport channel. Preferably shifted in a direction perpendicular to the rollers 42-47, three further rollers 39-41 are moreover rotatably mounted for conveying the bank notes in the area of the center between the individual transport channels 50-52 into the latter. This shifted mounting leads to a space saving. The individual rollers 39-47 can be disposed either above or below the guide surfaces 53-55 or preferably also in gaps of the guide surfaces 53-55. By way of example it is indicated in FIG. 5 e.g. that the three rollers 39-41 protrude into the transport channels 50-52 through gaps of the guide surfaces 53-55.

Moreover, the single diverter has on the inside with respect to the guide elements 53-55 a diverter vane 49 which is preferably designed in a delta form because of the Y form of the guide elements. The diverter vane 49 is shifted linearly between two end positions in the node area of the Y shape of the guide elements, e.g. by the drive by means of an actuator 48, e.g. a lifting magnet 48, to divert the bank notes in the desired way. The mesh of diverter vane 49 and guide elements 53-55 is preferably effected directly under the clamping places of the associated roller pair 42, 43, which is a special reason for the shifted mounting of said rollers relative to the others. The lifting magnet 48 will preferably be designed as a bistable magnet which can be switched between two positions, corresponding to the two end positions of the diverter vane 49.

The use of a lifting magnet in comparison with other actuators permits a particularly compact structure. In comparison with the rotary arrangement of the single diverters according to EP 0 811 208 B1, the above-mentioned solution with a linearly adjustable diverter vane is considerably simpler in structure and faster to switch.

Such a single diverter 38 thus makes it possible to realize four different transport directions, which are shown in FIG. 5. The two upper FIGS. 5a) and b) show a bidirectional path through which the bank notes can be conveyed from below to above, or vice versa, i.e. between the transport channels 51 and 52. For this purpose the diverter vane 49 is taken to the left to mesh with the guide elements 53, 55 by means of the actuator 48.

FIGS. 5c) and d) show two unidirectional paths for conveying the bank notes from the channel 52 to the channel 50 or from the channel 51 to the channel 50. For this purpose the diverter vane 49 is taken to the right to mesh with the guide element 54 by means of the actuator 48. In the bidirectional path the rollers 39-41, 44-47 are driven with an alternating direction of rotation; in the (only) unidirectional paths the rollers 42, 43 are driven with a constant direction of rotation.

The single diverters 38 are thus characterized e.g. in that they have one bidirectional and two unidirectional transport paths which interconnect the three outputs. Analogous variants are of course also conceivable for diverters with more than three inputs and outputs.

Diverter Module

FIG. 6 shows three different configurations for the diverter module 33. The diverter module 33 can be an arrangement of two single diverters 38, as were described e.g. with respect to FIG. 5. The shown embodiments are characterized in that the bidirectional path sections of the two single diverters 38 are series connected and thus the transport path 109 connecting them is drivable bidirectionally between the two single diverters 38 acting as transport path branches.

FIG. 6c) shows the configuration as is used in the basic module 2 according to FIGS. 1 and 2. The first single diverter 38 (the upper one in FIG. 6c)) has a unidirectional connection from the output 34 to the output 35, corresponding to a connection from the input or the singler (VE) to the return pocket (RJ) and from the output 34 to the remaining output 60. Moreover, there is a bidirectional connection to and from the output 60.

The third output 60 of the first single diverter 38 is connected via a transport channel with an output 61 of the second single diverter 38, which is in turn connected via a bidirectional connection with the output 36, corresponding to the escrow (ZK). Moreover, there is again a unidirectional connection in each case from the outputs 61 and 36 to the output 37, corresponding to the end cashbox (EK). This special configuration has the particular advantage that the optional escrow module 6 can be disposed in very space-saving fashion behind the basic module 2, i.e. to the left of the basic module 2 in the view of FIG. 1.

FIGS. 6a) and b) show two other connections of the two single diverters 38, corresponding to a mounting of the escrow (ZK) above (FIG. 6a)) or below (FIG. 6b)) the basic module 2. As mentioned, this flexibility of the potential arrangements of the individual modules is permitted precisely by using the diverter module 33 with a bidirectional transport path 109.

By merely adjusting the diverter vane 49 to one of its two end positions and by selecting the sense of rotation of the bidirectional transport path, it is possible to activate a desired transport section, e.g. between input/singler (VE), return (RJ), escrow (ZK) and end cashbox (EK).

As an alternative to the above use, such a single diverter 38 and/or such a diverter module 33 can for example also be used for cascading escrows, i.e. for parallel connection of two escrows and/or for resorting between escrows, e.g. in order to separate out preferred denominations when emptying a first escrow to the end cashbox and to resort them not into the end cashbox but into a further escrow as a module for providing change.

A further preferred application of such a diverter is that the bidirectional transport path of the diverter is connected to a turn-over module, or one of the channels of the bidirectional transport path is used itself as a turn-over module. This means that bank notes to be turned over, e.g. to permit bank notes to be always stacked front side up regardless of the input position, are transported through a first input/output of the single diverter 38 into the latter and forward into a section acting as a turn-over module to a second input/output and, by changing the sense of rotation of the bidirectional transport path, transported backward out of said second input/output again and through a third input/output out of the diverter and conveyed further in a turned-over position.

The diverter module 33 can basically also consist of a plurality of separate components, but it will preferably be a single part comprising all components shown in FIG. 6.

To permit access to the transport channels for clearing a jam, the diverter module 33 will preferably be designed so that it can be removed from the apparatus as a single part after fastening screws are loosened, and/or opened by being swung open. Thus, one or more transport path sections, preferably those with rollers not actively driven, are removable from the rest of the module case or can especially preferably be swung open, i.e. swiveled away, from the rest of the module case via a fastening axis.

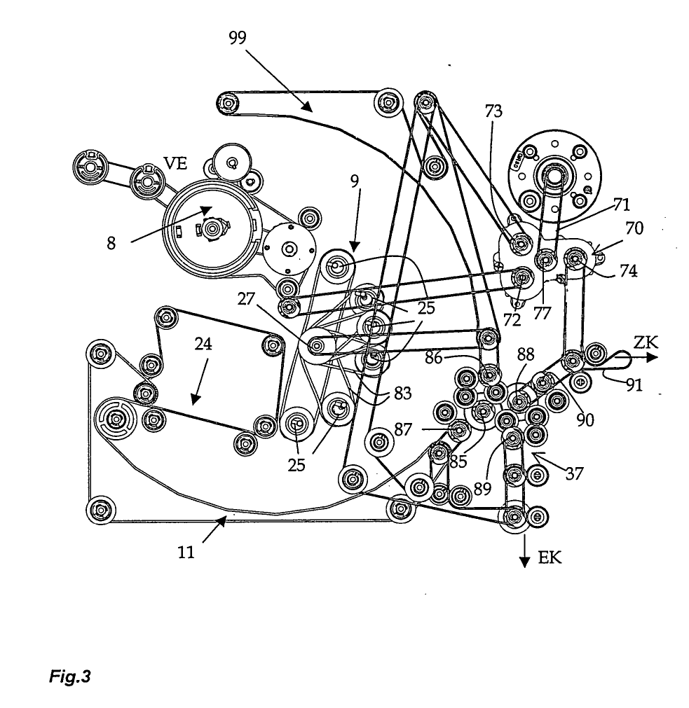

With the embodiment according to FIG. 6c) and the drive mechanism explained more exactly hereinafter with respect to FIG. 3, e.g. the three rollers in FIG. 6c) will be fastened above the upper guide element 55 of the upper single diverter 38 together with the latter in a common component of the module 33 which can be swiveled away from the rest of the module to expose the transport path in this area. This accessibility can also be given at an analogous place in the second single diverter 38. In such a case only the transport path 109 between the outputs 60 and 61 is not freely accessible for clearing a jam. Therefore this area will be designed as short as possible, in particular shorter than the smallest bank note normally used, i.e. preferably shorter than 100 mm, to permit any bank notes jammed therein to be easily removed.

Thus a long distance between the outputs 60 and 61 is shown only for clarity's sake. The distance will preferably be smaller so that for example the roller pairs 95 coincide at the outputs 60, 61, i.e. only one roller pair is present instead of the two roller pairs 95 shown.

Summing up, it can be stated that the presence of a single diverter module 33 for interconnecting the individual possible transport routes makes it possible to design the device 1 extremely compactly and flexibly in its arrangement. This compactness is supported further with this diverter arrangement, but would also be with others, by the transport paths from and to the measuring path, in the special case e.g. the aligning path 9 and the evaluating path 11, being curved in an arched shape.

Drive Unit

The drive of the transport path sections is effected, as mentioned, preferably via rollers and/or endless belts, in particular toothed belts. All transport path sections of the basic module 2 are driven particularly preferably by only one drive unit, a drive motor 12. The motor 12 is preferably a dc motor having e.g. a drive shaft rotating clockwise or counterclockwise in dependence on the polarity of the motor 12. To permit both unidirectional and bidirectional transport path sections to be driven simultaneously despite the use of only one motor 12, the motor 12 is connected to a direction of rotation converter transmission 70.

Direction of Rotation Converter Transmission

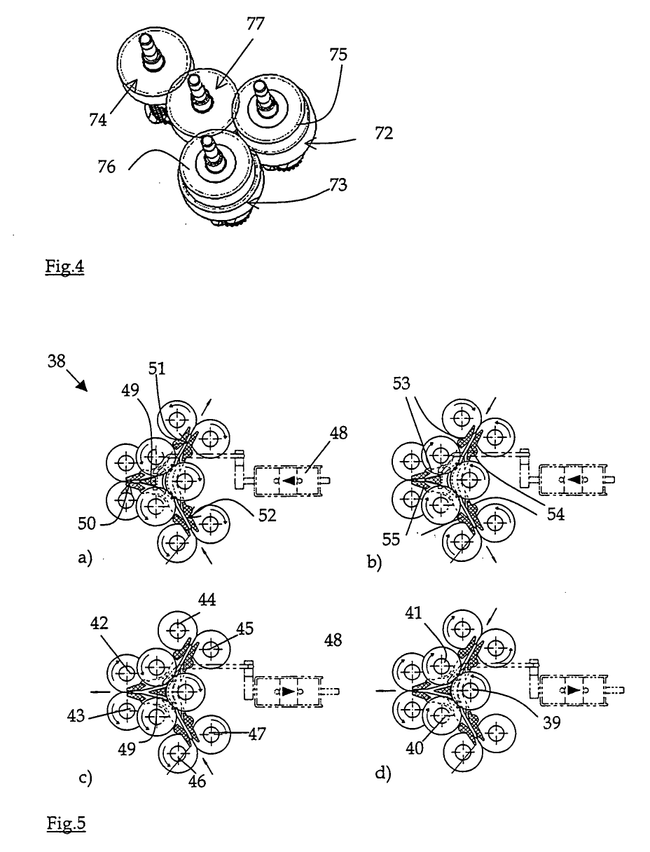

The function and the essential structure of the direction of rotation converter transmission 70, whose outer design is shown in FIG. 3, are apparent in particular from FIG. 4.

The motor 12 is connected via an endless belt 71 with the transmission input, i.e. in the case shown by way of example with the central shaft 77 of the direction of rotation converter transmission 70. (In the schematic view of FIG. 2 it is additionally indicated by means of a dotted line that said “central” shaft 77 can of course also be located at another position of the transmission 70.) The shaft 77 can be rotated in two directions of rotation (clockwise and counterclockwise) by pole reversal of the motor 12. The central shaft 77 is connected via a gear coupling to three further, likewise rotatably mounted shafts 72-74. The shaft 74 serves to drive the bidirectional transport path sections. This means that the gear coupling between central shaft 77 and the shaft 74 causes the shaft 74 to rotate counterclockwise when the shaft 77 rotates clockwise, and the shaft 74 to rotate clockwise when the shaft 77 rotates counterclockwise.

The transmission 70 thus provides for an alternating direction of rotation on the transmission input 77 a contrary alternating direction of rotation on the output shaft 74. The two other shafts 73, 75 moreover provide two contrary but always codirectional directions of rotation on the transmission output. The shaft 73 has a gear with a counterclockwise freewheel 76 as a locking device, and the shaft 75 a gear with a clockwise freewheel 75 as a locking device. Consequently, regardless of the change of direction of rotation of the central shaft 77 or the motor 12 driving it, the shaft 73 is always rotated counterclockwise and the shaft 72 always clockwise, to permit the unidirectional transport path sections to be driven with an unchanged direction of rotation by the same motor 12.

An advantage e.g. of such a direction of rotation converter transmission 70 is that different transport direction combinations can be realized with a single motor without electromechanical switching and coupling elements for example. It should be emphasized that the described embodiment is of course only a particularly preferred example and it is alternatively conceivable e.g. that the motor 12 is integrated in the shaft 77 itself and/or the number of driven shafts different, or it is not necessary for both clockwise and counterclockwise freewheeling shafts to be present.

Coupling to Direction of Rotation Converter Transmission

As shown in FIG. 3, the transmission 70 is connected by means of endless belts, such as toothed belts, to all rotatably mounted drive shafts of the transport paths of the basic module 2.

Bidirectional Transport Path Sections

The drive of the bidirectional transport path sections into or out of the escrow 6 via the diverter module 33 is effected by reversing the direction of rotation on the basic module drive motor 12. For this purpose the associated drive shafts are connected to the left-hand/right-hand rotating shaft 74 of the transmission 70. In the specific example of FIG. 3 these are only the central shaft 88 and the shaft 90 of the second single diverter 38 which leads to the escrow module 6. All other shafts to be rotated bidirectionally in the diverter module 33 require no separate drive, they corotate passively upon coupling of said two shafts 88, 90. Thus e.g. the central shaft 85 of the first single diverter 38 of the diverter module 33 is connected via a beltless gear coupling directly to the central shaft 88 of the second single diverter 38.

Unidirectional Transport Path Sections

The drive shafts of the unidirectional transport path sections from singler 8, aligning path 9, measuring path 24, evaluating path 11, transport path 99 to the return pocket and the transport path 100 into the end cashbox 4 via the cassette carrier 3 are connected via endless belts to the unidirectional drive shafts 72, 73, to be always driven in the same direction via the direction of rotation converter transmission 70 independently of the reversal of the direction of rotation of the drive motor 12.

With respect to the diverter module 33 it should also be noted in this connection that only the unidirectionally rotating shafts 86, 87, 89 and 90 are coupled via belts with the unidirectional shafts 72, 73 of the transmission 70, while all other shafts of the diverter module 33 are again only corotated passively during operation. As mentioned above, precisely this direct drive of only some of the shafts permits the diverter module 33 to be designed so that the transport paths can easily be made accessible by removing or swinging away the sides with undriven shafts, e.g. for clearing a jam.

The singler 8 is further preferably driven for example via a toothed belt coupling by the unidirectional output 72 of the direction of rotation converter transmission 70. This also realizes the necessary reduction to the singler 8, i.e. the preferred speed increase from the singler 8 to the connected transport system. The singler is the only unidirectional transport path section that is driven by the shaft of the output 72. All other unidirectional transport path sections are driven by the further unidirectional shaft 73.

The aligning path 9, on the other hand, is driven by the unidirectional output 73 of the direction of rotation converter transmission 70. It should be particularly noted that a plurality of, particularly advantageously all, aligning wheels 25 are connected via associated belts 83 to a single actively driven shaft 27 which is coupled with the output 73 of the transmission 70. This space-saving arrangement is particularly advantageous for the selected arched transport path 9.

The measuring path belt loop 24 is entrained by the following flat belt loop of the evaluating path 11, thus requiring no separate drive.

Since the transport in the aligning path 9 necessarily involves slip, the pull-off speed of the singler 8, the speed of the aligning wheels 25 and the transport speed of the measuring path 24 must be coordinated with each other so that the slowest bank note is faster than the pull-off speed of the singler 8 and the fastest bank note slower than the transport speed in the measuring path 24.

Jam Detection

Detection of a bank note jam in the transport system can be effected advantageously in the described or also other devices by dynamically monitoring regulating parameters for controlling the transport. An evaluation software will for this purpose ascertain sudden changes in the power demand, which indicate a suddenly occurring jam in the transport paths. Jamming of a bank note in the transport path can lead for example to a strong change in the necessary power for driving the transport rollers at a predetermined speed. Basically desirable changes in the power demand of the system that are caused by a predetermined connection of further system components are taken into account and hidden by the evaluation software during evaluation.

Escrow

An escrow 6, also known as a buffer 6, is understood in the normal way to mean a device for temporarily receiving bank notes, which is preferably used to offer a depositor the possibility to abort a cash deposit operation to permit the bank notes of said cash deposit operation stored in the escrow 6 to be completely outputted again.

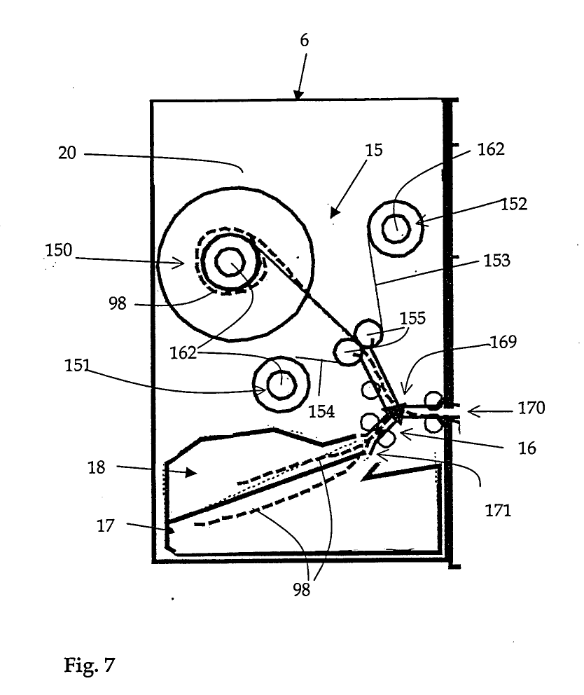

The optional module of the escrow 6 is shown in particular in FIG. 7. It has, as functional assemblies, a film storage 15, normally also known as a winding or roller storage, a transport path 16, a storage pocket 17 for retracted bank notes, referred to as the retract bin 17 for short, a storage pocket 18 for suspicious bank notes and a control unit not shown, which are all mounted on a chassis 20. The transport path 16 comprises a diverter 169 which connects the input 170 of the escrow 6 through which the bank notes are supplied from the basic module 2, via a bidirectional transport section to the film storage 15 and via a unidirectional section to the storage pockets 17, 18 into which bank notes can alternatively be inputted by insertion of a further diverter 171. The diverter 169 can again be e.g. a single diverter 38, as was described with respect to FIG. 5.

Drive

As indicated in FIG. 3 by the belt 91 coupled with the shaft 74, the motor 12 of the basic module 2 can preferably also be used to drive corresponding shafts to be rotated bidirectionally in the escrow 6 connected to the basic module 2. A mechanical connection with intermeshing elements is realized here and the drive coupling is effected by laying on the drive belt 91.

Via said drive belt 91 the transport path 16 in the escrow 6 is driven. This ensures that the escrow transport path 16 has the same speed as that of the basic module 2.

Retract Bin

The retract bin 17 is understood here to be a storage pocket for the deposit of retracted bank notes, i.e. bank notes that the depositor has not taken out of the return area in the case of an aborted input transaction. The number of such bank notes is indefinite since it cannot be sure whether the depositor has pulled some bills out of the bundle to be returned or has replaced some bank notes by cuttings. If it is undesirable for the end cashbox content to become undefined, said (remaining) retracted bank notes will therefore not be deposited into the end cashbox 4.

The retract bin 17 and the storage pocket 18 for suspicious bank notes will preferably be designed as removable boxes.

Film Storage

In the embodiment described by way of example the film storage 15 consists substantially of three spools 150-152 and two film strips 153, 154. Two of the spools 151, 152 serve as dispensing spools for receiving the two films 153, 154 in the emptied state of the buffer 6. The third spool 150 serves as a storage spool, having both films 153, 154 and the bank notes to be stored wound thereon in the storage operation.

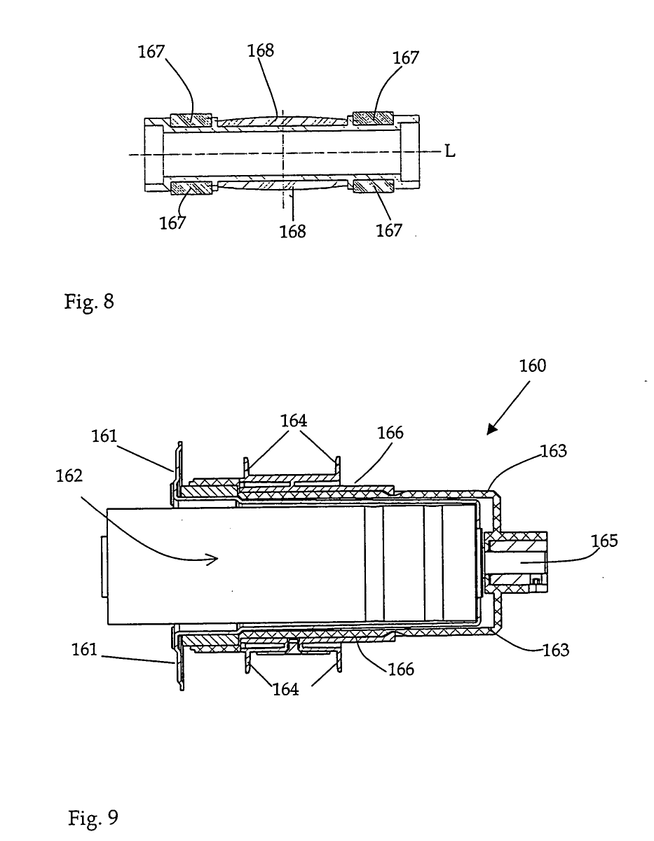

The two films 153, 154 are guided from the dispensing spools 151, 152 onto the storage spool 150 each via a peeling roller 155, as shown in a cross-sectional view in FIG. 8 by way of example. The bank notes to be stored are held between the two films 153, 154 and the two peel rolls 155. Upon storage of the bank notes the latter are consequently brought into a pressed state and thus fixed until being moved out again. Bank notes of better or worse quality are thus held in equally defined fashion regardless of their state.

The films 153, 154 are preferably chosen so as to be narrower than the smallest bank note, e.g. 30 mm wide at a smallest bank note width of 60 mm.

Spool Motor

Although it is also possible to rotate the individual spools 150-152 via coupling of an external rotating motor by means of a belt coupling, some and in particular all spools 150-152 will preferably be driven and controlled by their own dc motor. One of the essential separate ideas of the present invention is that the motor is not mounted externally at a distance, but within the particular spool itself. The compact structure of such a spool has only a small space requirement and moreover increases the accessibility and service friendliness in the device. It should be emphasized that this idea, too, can be used not only in one of the devices described here, but also for other shafts to be rotated and especially advantageously also for differently used film storages.

Such a spool 160, which can e.g. be one of the spools 150-152 according to FIG. 7, has in the shown embodiment by way of example substantially five parts, as can be seen in the cross-sectional view of FIG. 9. A motor pot 161 is fixed unrotatably to one wall of the housing 20 of the escrow 6. The motor pot 161 serves as a receiving means for a dc motor 162 likewise mounted in fixed and unrotatable fashion. At the front end of the motor 162 the latter has a shaft 165 which rotates around its longitudinal axis in accordance with the polarity of the dc motor 162. The shaft 165 has fastened thereto as a rotating part a spool carrier 163 which corotates with the shaft 165. The motor pot 161 thus serves at the same time as a contact surface for a needle bearing 166 pressed into the spool carrier 163 and carrying the spool core 164. The spool core 164 is the carrier of the film 153, 154 and can be removed from the spool carrier 163 when required. By pole reversal of the motor 162 the shaft 165 thereof and thus the spool carrier 163 is consequently corotated with the spool core 164.

Peeling Rollers:

FIG. 8 shows a cross section through one of the stated peeling rollers 155. The two narrow films 153, 154 and the peeling rollers 155 are coordinated with each other so to as realize reliable peeling of the bank notes from the films 153, 154 when the film storage 15 is emptied.

When the bank notes are located between the peeling rollers 155, they lie on the film 153, 154 and on e.g. two soft rings 167 made e.g. of rubber, which are located e.g. at end areas with respect to the longitudinal axis L of the peeling roller 155. The bank note is guided reliably between the films 153, 154 by the high coefficient of friction of the soft rubber rings 167. The diameter on which the film rests is preferably slightly less than that of the rubber rings 167. This produces a speed difference upon rotation of the peeling roller 155, which is useful particularly upon moving out of the film storage 15 in order to remove e.g. strongly soiled or adhesive bank notes from the films 153, 154. With these bank notes there would otherwise be a danger that they stick to the films and cannot be conveyed back to the transport route.

Preferably a hard ring 168 made e.g. of rubber is provided, preferably in a convex form, between the soft rubber rings 167 to obtain reliable guidance of the films 153, 154. Said rubber ring 168 is particularly preferably harder than the two outer rings 167.

Besides the above-mentioned embodiments, numerous other variants are conceivable.

Cascading Escrows

The capacity of the escrow 6 can thus be increased by cascading two or more escrows, e.g. specifically two or more film storages 15. The escrows are preferably of identically construction. The bank notes are e.g. supplied first to one of the escrows via a diverter and, when it is full, to another of the escrows by switching the diverter.

Omission of Escrow

The case described in particular above was moreover that the basic module 2 has mounted thereon an escrow module 6 for intermediately storing the bank notes inputted into the input pocket 7 after singling and testing until the operator gives his consent to final retention and thus deposit of the bank notes from the escrow 6 into the end cashbox 4.

However, it may also be that for depositors not desiring the option of being able to abort a pending transaction so that they are returned the inputted bank notes, the bank notes are transported directly into the end cashbox while bypassing the escrow. This case can be relevant e.g. for customers who are convinced of the accuracy of detection of the deposited bank notes and want to save time by not having to confirm the actual retention of the inputted bank notes every time, in particular when they make deposits regularly.

But it is preferable for not all deposited bank notes to be fundamentally transported and deposited directly into the end cashbox 4 while bypassing the escrow 6, but only those whose authenticity and/or value has been previously confirmed or determined in the sensor device 10, so that they can optionally also be credited directly during or after completion of the particular deposit transaction. It is conceivable that the escrow module 6 is completely omitted in the described case. Alternatively, there can also be user-dependent control of the device. This means e.g. that the particular operator either has a choice between using or omitting the intermediate storage during a deposit transaction or this decision is at least set by default in user-specific fashion.

Output of Bank Notes

A further separate idea of the present invention is the following. For example some ticket machines typically do not accept bank notes of great denomination since payout is always done in coin. With use of a deposit device having an escrow such as a film storage, however, bank notes of certain denominations can also be stored intermediately and outputted again as change. That is, one idea is to use the buffer for storing bank notes that can then be outputted again in the same transaction, or in particular in subsequent transactions, regardless of whether the depositor wishes to abort a pending transaction.

It is thus firstly possible e.g. that bank notes of a single denomination are pre-stored in a film storage and outputted again as change in a transaction if necessary. If for example 5-euro bank notes are stored as change in the film storage and the customer inputs e.g. two 10-euro bills in a transaction, the latter can be stored intermediately in said film storage and deposited into the end cashbox upon confirmation of the transaction. If the customer is to receive change of at least 5 euros in the transaction, a corresponding number of 5-euro bills is then outputted from the film storage as (part of the) change.

Alternatively or additionally, it is also possible that, in a deposit transaction, when the first bank note or bank notes inputted into the film storage first are precisely bank notes of this predetermined denomination, they remain as possible change in the buffer upon emptying thereof, while all other bank notes, i.e. those inputted into the buffer subsequently in this transaction, are transported into the end cashbox upon completion of the transaction.

In these cases the buffer is not always emptied completely at the end of a transaction, but it is possible that a certain number of bank notes of a predetermined denomination remain in the escrow as possible change. This procedure provides more ease of use, since high-value bank notes can also be inputted and lead in particular in the last-named variant to considerably fewer cassette changes.

It is not necessary here that only one denomination per buffer is prestored as possible change. Bills of several denominations can also be used in a film storage. In this case the control program of the film storage must only know which denominations are stacked at which place in the film storage. In this case the control program can be designed so that it outputs one or a combination of several desired bank notes again and possibly necessarily because of the sequential storage at the same time transports into the end cashbox bank notes also removed from the film storage but not to be outputted again as change. Particularly preferably, two denominations can also be stored alternatingly in this case.

Cassette Carrier

The cassette carrier 3 serves as an interface between basic module 2 and end cashbox 4 for securing and monitoring the end cashbox 4. It has, as functional assemblies, a skeletal structure 101 provided with, among other things, a transport path 21 having e.g. single roller pairs 28, a locking unit (not shown) and drive elements 22 for the end cashbox 4 and for the transport path 21. The skeletal structure 101 advantageously moreover has a pivoting frame (not shown) with receiving rails for the end cashbox 4, said frame being particularly advantageously designed so that the end cassettes 4 can be inserted and removed through associated doors in the safe 5 both from the front and from the back depending on the application case.

The locking unit can be provided with bolt and lock, the lock preferably requiring a key different from the end cassette 4 to permit different access authorizations for removing and for opening the end cassettes 4.

Further, an interface can be present for identification of the end cassette 4.

External Cassette Drive

A further advantageous idea of the present invention is that some, particularly preferably all, drive and control elements for the end cashbox 4 are integrated in the cassette carrier 3. Since only the externally driven (mechanical) components remain in the cassette 4, the costs and weight of the end cassette 4 are significantly reduced and the reliability increased. The driven interfaces from the cassette carrier 3 to the end cashbox 4 are e.g. the drive of the transport rollers 114 of the end cassette 4, the drive 103 of a pusher 102 for pressing down inputted bank notes, and the drive 105 of a stamp unit 104 as to be described in more detail hereinafter. Moreover, reed contacts can be present in the cassette carrier 3 for determining the stamp position and for filling level detection.

A further essential idea of the present invention is that only mechanical couplings are used, e.g. a gear coupling for driving the transport rollers 28 of the end cassette 4, and/or magnetic couplings such as the above-mentioned reed contacts.

This permits the cassette 4 to be simply designed and mounted on the cassette carrier 3 without electric connections. This is advantageous because no electric contacts are necessary, which in longer use would soil particularly easily and thus work unreliably.

Via the cassette carrier 3 the end cassette 4 is fed with bank notes to be stored. The sequence for a cassette change can be executed as follows: placing the cassette 4 on the guide rails of the pivoting frame of the skeletal structure 101 and inserting it up to a stop, swinging in the end cassette 4 against the force of a spring up to the end stop. In this working position it is swiveled and locked. Swiveling in the end cassette 4 causes the drive elements to be connected to the mechanical assemblies of the end cassette 4. The reed contacts for determining the stamp position and those for the filling level detection are thereby positioned automatically. The contacts for cassette identification are closed.

End Cashbox

The end cashbox 4 can be executed as a free-fall cassette or a stacking cassette 4. The stacking cassette 4 has by way of example a storage area 110 with a sprung deposit plate 111. The bank notes are delivered singly from the transport rollers 28 of the cassette carrier 3 to the transport rollers 28 of the cassette 4 disposed flush therewith. Through delivery opening 115 the bank notes reach the cassette 4. Due to the narrow delivery opening 115 and a following deflection of the bank notes by 90° it is impossible to manipulate the cassette contents.

The singly introduced bank notes are stacked on a tray 112. The tray 112 is located below the stamp unit, e.g. in the form of a scissor-type stamp 104. To guarantee reliable stamping, said tray consists of two swivel plates rotatably mounted on the left and right of a side wall. The two plates are sprung and can be swiveled downward against the spring force. The distance apart, i.e. the stamp-through opening, is normally approx. 40 mm. The stamped in bank notes 113 are pressed against the tray 112 from below by the sprung deposit plate 111.

Upon insertion into the cassette carrier 3 the empty end cassette 4 is first pushed until the stop into the pivoting frame. In this working position the cassette 4 is locked via the locking unit. The swivel motion causes the drive units 103, 105 for stamp 104 and pusher 102 and the transport rollers 28 situated in the cassette itself to be engaged when the cassette 4 is swung into the working position. At the same time the reed contacts for stamp position and filling level detection as well as the contacts of the cassette detection are closed. To guarantee operativeness, a functional test is performed on the inserted cassette after locking.

In other words, the bank notes are first stacked on the tray 112. The stacking operation is supported by the pusher 102. After stack formation the stamp 104 moves downward and stamps the paid-in bank notes through the swiveling tray 112 onto the sprung deposit plate 111. When the bank-note bundle is completely stamped through, the two swivel plates of the tray 112 swivel upward and retain the bank notes 113 in the transport storage of the cassette 4 when the stamp 104 moves back.

A door (not shown) of the cassette 4 is secured by a lock. When the cassette 4 is closed, a bolt with state tagging is released which engages a guide groove of the cassette 4. Said bolt is activated upon insertion of the cassette 4 by the guide rail of the cassette carrier 3 and closes the guide groove upon removal. It is thus impossible to insert the cassette 4 without previously emptying it.

Cassette Chip

An electronic storage medium 116 is optionally provided in the cassette 4 for storing transaction data, such as data on the depositor of bank notes and/or the inputted bank notes. Said storage medium 116 can additionally or alternatively be used for automatic identification of the particular cassettes 4 inserted into the cassette carrier 3 of the deposit device 1.

It is particularly advantageous to use a chip 116 which can be contacted, and thus read in and/or out, via a single contact and an additional grounding, and is advantageously housed in a metal case, such as a high-grade steel case, the contacting being done by contacting the metal case of the chip 116 with a countercontact 117 of the cassette carrier 3. As opposed to the use e.g. of smart cards, this simplifies the writing and/or readout of data and permits reliable contacting even when the cassettes 4 are handled roughly.

The chip 116 is preferably provided with unique identification data, which are allocated e.g. in the course of production of the cassette 4 and can then no longer be changed.

Multiple Cassettes

The cassette volume cannot be enlarged at will to permit large quantities of money to be stored in a deposit device 1 when required. One solution is to provide a possibility of fastening by which two or more cassettes 4 can optionally be mounted on the deposit device 1. Thus e.g. two cassettes can be mounted displaceably and/or rotatably in a structure e.g. of the cassette carrier 3, so that displacing and/or rotating the structure will bring the input opening of one of the cassettes 4 in alignment with the delivery point 115 of the cassette carrier 3.

Alternatively, a separate delivery point 115 can be provided in each case for several, in particular all, cassettes, the bank notes being supplied alternatively to the individual cassettes via diverters in the cassette carrier. The individual cassettes can moreover be stacked either horizontally under each other or vertically beside each other. Horizontal mounting in the presence of a single cassette, but also of the several cassettes described here, has the special advantage of being very space-saving.

A further idea is that the individual cassettes also have several, in particular two, deposit areas. In this case a separate insertion opening will be present for example for each deposit area, being made to couple in each case with the delivery opening, or one of the delivery openings, to permit bank notes to be inserted.

It should further be noted that the above-described embodiments are not only intended for processing, i.e. depositing, bank notes. It is also conceivable to provide the apparatus with a possibility for inputting and processing checks and/or coins.

Finally, it should be particularly emphasized that the individual features of the dependent claims and/or embodiments stated in the description can also be advantageously used independently of each other and of the subject matter of the main claim in other bank note processing apparatuses, in particular in other bank note deposit apparatuses.

1. An apparatus (1) for processing bank notes (113) having a transport system with a plurality of transport paths (9, 11, 24, 33, 99, 100, 107, 109) for transporting bank notes,
characterized in that
the transport system has a diverter device (33) with a bidirectionally drivable transport path (109) between two transport path branches to permit bank notes in said transport path (109) to be transported in two opposite directions.

2. An apparatus according to claim 1, characterized in that the diverter device (33) has a diverter module (33) with at least four inputs/outputs (34-37).

3. An apparatus according to claim 2, characterized in that the diverter module (33) is a separate part which is adapted to be removed, swung open, or a combination thereof.

4. An apparatus according to claim 1, characterized in that the diverter device (33) has two single diverters (38) each with at least three inputs/outputs (34-37, 60, 61), a first input/output (60) of the first single diverter being connected or connectable to a first input/output (61) of the second single diverter.

5. An apparatus according to claim 4, characterized in that the connection between the first input/output (60) of the first single diverter to the first input/output (61) of the second single diverter forms the bidirectional transport path (109) between the two transport path branches.

6. An apparatus according to claim 1, characterized in that at least one or both of the single diverters (38) each have a diverter vane (49) adapted to travel between two positions to divert bank notes alternatively to one of the inputs/outputs (34-37, 60, 61) of the particular single diverter.

7. An apparatus according to claim 6, characterized in that the diverter vane (49) is displaceable between the two positions in a straight line and/or by means of an actuator, in particular a bistable magnet.

8. An apparatus according to claim 1, characterized in that the apparatus is an apparatus (1) for depositing bank notes (113) which has an input device (7) for inputting bank notes to be deposited and at least one of the following parts: a singler (8) for singling inputted bank notes, a sensor device (10) for testing properties of inputted bank notes, an escrow (6) for temporarily storing inputted bank notes, an end cashbox (4) for final deposit of inputted bank notes, and a return device (19) for returning inputted bank notes.

9. An apparatus according to claim 8, characterized in that the transport system has a first transport path (100) which is connected or connectable to the end cashbox (4) for depositing inputted bank notes, a second transport path (107) which is connected or connectable to the escrow (6), a third transport path (9, 11, 24) which is connected or connectable to the input device (7), a fourth transport path (99) which is connected or connectable to the return device (19), or a combination thereof.

10. An apparatus at least according to claim 2, characterized in that the first to fourth transport paths are each connected or connectable to a different one of the four inputs/outputs (34-37) of the diverter module (33).

11. An apparatus according to claim 10, characterized in that the third transport path is connected or connectable to a second input/output (34) of the first single diverter, the fourth transport path to a third input/output (35) of the first single diverter, the first transport path to a second input/output (37) of the second single diverter, and the second transport path to a third input/output (36) of the first single diverter.

12. An apparatus according to claim 1, characterized by a direction of rotation converter transmission (70) having a transmission input (77) with a changing direction of rotation, a first transmission output (74) with a changing direction of rotation and a second transmission output (72, 73) with an always codirectional direction of rotation.

13. An apparatus according to claim 12, characterized in that the direction of rotation converter transmissions (70) further has a third transmission output (72, 73) with an always codirectional direction of rotation contrary to the direction of rotation of the second transmission output (72, 73).

14. An apparatus according to claim 12, characterized in that the transmission input (77) is coupled via a gear coupling with the transmission outputs (72-74), the always codirectionally rotating input transmission output or outputs (72, 73) have a freewheel (75, 76), or a combination thereof.

15. An apparatus according to claim 12, characterized by a drive unit (12), such as a dc motor (12), which is coupled with the transmission input (77) of the direction of rotation converter transmission (70).

16. An apparatus according to claim 1, characterized in that the first transmission output (74) is connected to bidirectional transport paths of the transport system, and at least one of the second and third transmission output to unidirectional transport paths of the transport system.

17. An apparatus according to claim 9, characterized in that the direction of rotation converter transmission (70) is connected to at least one of the first to fourth transport paths, and the singler (8), for driving the same.

18. An apparatus at least according to claim 8, characterized by a control device (13) which controls the diverter device (33) in dependence on a user-specific default such that inputted bank notes are alternatively either diverted into the escrow (6) or transported into the end cashbox (4) while bypassing the escrow (6).

19. An apparatus according to claim 18, characterized in that the user-specific default is prestored in the apparatus (1) or externally, can be inputted by the user by means of an operating unit, or a combination thereof.

20. An apparatus according to claim 1, characterized by a bank-note storage (15) having in particular a film storage (15) with at least one rotatably mounted spool core (164) on which at least one film strip (152, 154) can be wound and unwound.

21. An apparatus according to claim 1, characterized in that the spool core (164) is fastened to an output shaft (165) of a motor (162) such that rotation of the output shaft of the motor causes the spool core to corotate.

22. An apparatus according to claim 1, characterized in that the apparatus (1) has a cassette carrier (3) with at least one of a fastening and locking unit for an end cashbox (4), and a further transport path (21) for supplying bank notes from the first transport path (100) to the end cashbox.

23. An apparatus according to claim 22, characterized in that the cassette carrier (3) has at least one of mechanical, optical and magnetic drive and control elements (103, 105) for the end cashbox (4) to permit the latter to be driven or controlled free from electric contacts.

24. An apparatus according to claim 1, characterized in that the diverter device (33) is mounted between two escrows for transporting bank notes between the two escrows serves as a turn-over module, is connected or connectable to a turn-over module for turning over the position of bank notes, or a combination thereof.

25. An apparatus at least according to claim 8, characterized by a control device for driving the escrow which is designed so that, in a deposit transaction, bank notes stored temporarily in the escrow can be outputted again in the pending, or at least one following transaction, or a combination thereof, regardless of whether the pending deposit transaction is aborted.

26. An apparatus at least according to claim 8, characterized by a control device for driving the escrow which is designed so that, in a pending deposit transaction, bank notes first introduced into the escrow (6) remain therein if they are bank notes of a predetermined denomination, a predetermined sequence of different denominations, or a combination thereof, whereas the remaining bank notes temporarily stored in the escrow in the pending transaction are transported to the return device if the pending transaction is aborted, or to the end cashbox if the pending deposit transaction is confirmed by the user.

27. The apparatus of claim 17 wherein the connection of said transmission is via endless belts.

28. The apparatus of claim 22 wherein said cashbox is bank note cassette.
